(19) United States
(12) Patent Application Publication
(10) Pub. No.: US 2014/0116543 A1
(43) Pub. Date: May 1, 2014

(54) FUEL SUPPLY SYSTEM

(71) Applicant: HONDA MOTOR CO., LTD., TOKYO (JP)

(72) Inventors: HIROYUKI KOJIMA, Saitama-shi (JP); TAKUYA MITO, Utsunomiya-shi (JP); AKIO YAMANAKA, Shimotsuke-shi (JP); KEITA ISHIZAKI, Tokyo-to (JP); AKIRA ISAYAMA, Utsunomiya-shi (JP)

(73) Assignee: HONDA MOTOR CO., LTD., TOKYO (JP)

(21) Appl. No.: 14/062,022

(22) Filed: Oct. 24, 2013

(30) Foreign Application Priority Data
Oct. 25, 2012 (JP) 2012-236021

(51) Int. Cl. F02M 27/00

(52) U.S. Cl. CPC F02M 27/00
USPC 137/561 R

(57) ABSTRACT

A fuel supply system includes a fuel tank, a filler pipe through which fuel is supplied to the fuel tank, and a storage tank in which a fuel additive that is to be supplied to the fuel tank is stored. An extended portion is formed at a portion adjacent to a communication port of the filler pipe and to which fuel directly flows when the fuel is supplied to the fuel tank. The fuel tank includes an injector that injects the fuel additive from the storage tank into the fuel tank. The fuel additive is injected into the extended portion.

### CROSS REFERENCE TO RELATED APPLICATION

The present application claims priority under 35 U.S.C. §119 to Japanese Patent Application No. 2012-236021, filed Oct. 25, 2012, entitled “Fuel Supply System.” The contents of this application are incorporated herein by reference in their entirety.

### BACKGROUND

The present disclosure relates generally to a fuel supply system, and more specifically, to a fuel supply system that includes a fuel additive supply system for storing a fuel additive and supplying the fuel additive to a fuel tank.

At least one known fuel system automatically supplies an appropriate amount of fuel additive, such as a fuel borne catalyst (FBC), into a fuel tank for a diesel engine. The system may include components such as a supply tank, in which the fuel additive is stored, and a positive displacement pump, which supplies the fuel additive to the fuel tank via a line or a filter.

For example, the amount of the fuel additive supplied to the fuel tank may be estimated based on the typical fuel consumption rate for a given vehicle to maintain an average concentration in the fuel within a predetermined range from approximately 1 ppm to approximately 20 ppm.

Light oil is typically employed as fuel for diesel engines, the specific gravity of which differs from the specific gravity of FBCs to a large extent (FBCs have a higher specific gravity than the light oil). Thus, after an FBC is poured into fuel in a fuel tank, the FBC accumulates in a lower end portion inside the fuel tank and does not sufficiently spread throughout the light oil in the tank.

If the FBC does not sufficiently spread throughout the light oil and the concentration of the FBC in the light oil deviates downward from the reference range (i.e., if the concentration of the FBC falls below the reference range), the amount of combustion of particulate matter (PM) at the time of regeneration of a diesel particulate filter (DPF) may be reduced and an excessive amount of PM may accumulate in the DPF.

### BRIEF DESCRIPTION

In one aspect, a fuel supply system is provided. The fuel supply system includes a fuel tank and a filler pipe connected to the fuel tank and through which fuel is supplied to the fuel tank. The fuel supply system also includes a storage unit in which a fuel additive that is to be supplied to the fuel tank is stored. The holding portion is formed in a portion of an inside of at least one of the filler pipe and the fuel tank to which the fuel directly flows when the fuel tank is supplied with the fuel. Furthermore, the fuel tank has an inlet through which the fuel additive is injected from the storage unit into the fuel tank. Moreover, the fuel additive is injected into the holding portion.

In another aspect, a method for supplying a fuel additive to fuel in a fuel tank is provided. The method includes positioning the fuel additive injector substantially above the holding portion of the fuel supply system, and positioning the holding portion of the fuel supply system in a path of a flow of fuel introduced into the fuel tank from the filler pipe.

In yet another aspect, a fuel additive supply system associated with a fuel tank is provided. The supply system includes a holding portion defined at least partially within at least one of the fuel tank and a filler pipe associated with the fuel tank. The supply system also includes a fuel additive storage unit configured to store a fuel additive and a fuel additive injector coupled to at least one of the fuel tank and the filler pipe in a position above the holding portion and configured to provide the fuel additive to the holding portion.

### BRIEF DESCRIPTION OF THE DRAWINGS

FIG. 1 is a schematic diagram of a fuel supply system according to an embodiment of the present disclosure.

FIG. 2A and FIG. 2B are schematic diagrams of alternative embodiments of the holding portion shown in FIG. 1.

FIG. 3A and FIG. 3B illustrate the fuel additive concentration in fuel in the fuel supply systems shown in FIG. 1, FIG. 2A, and FIG. 2B.

FIG. 4A and FIG. 4B illustrate the fuel additive concentration in fuel according to a comparative example.

FIG. 5 is a timing chart illustrating an exemplary relationship between timings of multiple fuel supply operations and fuel-additive injections and the ignition state (IG-ON or IG-OFF) of a vehicle that includes the fuel supply system shown in FIG. 1.

### DETAILED DESCRIPTION

In view of the above circumstances, the present disclosure describes a fuel supply system that maintains the concentration of a fuel additive in fuel at a predetermined value or higher to prevent diesel particulate filter (DPF) regeneration efficiency from decreasing.

In the exemplary embodiment, a fuel supply system includes a fuel tank; a filler pipe connected to the fuel tank and through which fuel is supplied to the fuel tank; and a storage unit in which a fuel additive that is to be supplied to the fuel tank is stored. A holding portion is formed in a portion of an interior of either the filler pipe or the fuel tank to which the fuel directly flows when the fuel tank is supplied with the fuel. The fuel tank includes an inlet that injects the fuel additive from the storage unit into the fuel tank. The fuel additive is injected into the holding portion.

In the exemplary embodiment, the fuel additive injected into the holding portion is spread by the flow of fuel introduced into the fuel tank during a fuel supply operation, and thus the concentration of the fuel additive in the fuel can be kept at or higher than a predetermined value due to a dispersing effect of the flow of fuel.

Furthermore, combustion of PM during DPF regeneration is facilitated and accumulation of PM in the DPF is substantially prevented. Consequently, the concentration of the fuel additive in the fuel can be kept at or higher than a predetermined value and the DPF regeneration efficiency can be advantageously prevented from decreasing.

In the exemplary embodiment, the holding portion is an extended portion formed such that a fuel-tank-side end portion of the filler pipe extends into the fuel tank.

In the exemplary embodiment, the fuel additive is injected in advance while the engine is running, and the injected fuel additive is kept in the extended portion, which extends toward the fuel tank, until a subsequent fuel supply operation is performed. Moreover, by driving a fuel pump at an actuation of the engine after a fuel supply operation is performed, the fuel additive can be made to more effectively spread by the flow of fuel and can be efficiently agitated in the fuel tank.

In the exemplary embodiment, an amount of the fuel additive to be injected may be determined based at least partially on the amount of fuel supplied immediately before the injection of the fuel additive.

Furthermore, the amount of the fuel additive to be injected may be determined based at least partially on the amount of fuel provided to an engine immediately before the injection. Thus, the fuel additive can be kept in the holding portion (e.g., extended portion) in accordance with the flow of fuel into and out of the fuel tank.

Accordingly, a fuel supply system that can maintain the concentration of a fuel additive in fuel at a predetermined value or higher to prevent the DPF regeneration efficiency from decreasing can be manufactured.

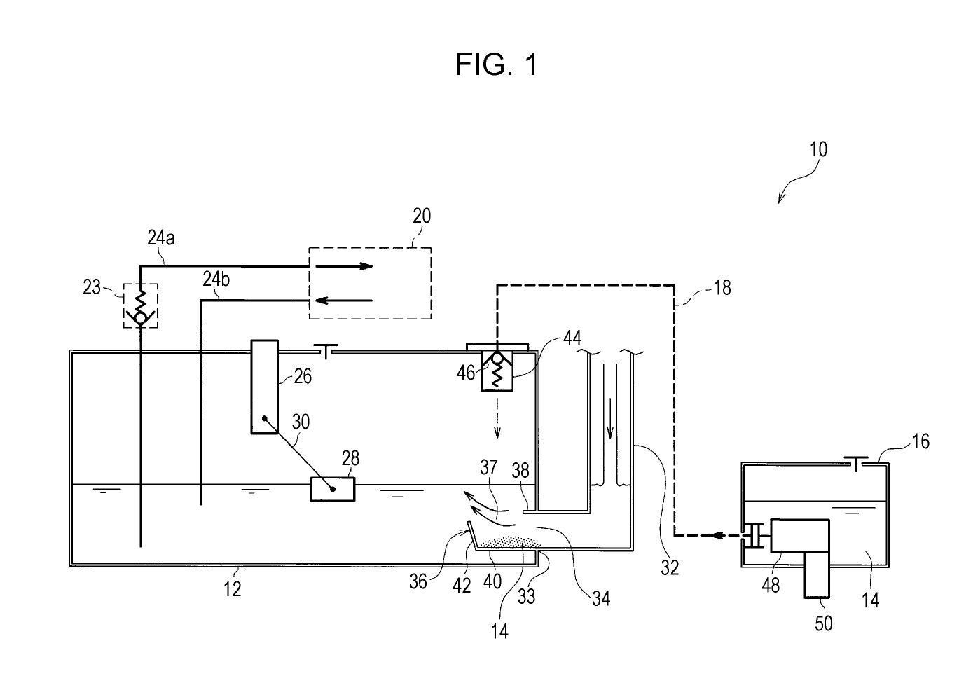

FIG. 1 is a schematic diagram of an exemplary embodiment of a fuel supply system 10. In the exemplary embodiment, fuel supply system 10 includes a fuel tank 12, a storage tank (e.g., storage unit) 16, which is separate from the fuel tank 12 and in which a fuel additive 14 is stored, and an additive inlet pipe 18 that connects the fuel tank 12 to the storage tank 16. In the exemplary embodiment, the fuel additive 14 may include, but is not limited to, a fuel borne catalyst (FBC) having a larger specific gravity than light oil serving as fuel for diesel cars.

The fuel tank 12 is, for example, a resin component made by blow molding, and is disposed under the floor below the rear seat of a vehicle (not shown in FIG. 1). Examples of the shape of the fuel tank 12 include a flat shape having a small thickness in the vertical direction to facilitate a relatively low cabin floor and low center of gravity of the vehicle and a saddle shape that is curved so as to avoid a propeller shaft extending in the vehicle front-rear direction.

A fuel pump (not shown in FIG. 1) may be disposed near an engine, for example, a diesel-vehicle engine 20. The fuel pump draws fuel from the fuel tank 12 via a suction filter (not shown in FIG. 1), and ejects the fuel in a pressurized state. The fuel pump supplies the fuel in the fuel tank 12 to the engine 20. A fuel supply pipe 24a, through which fuel is supplied to the engine 20 via a check valve 23, and a fuel return pipe 24b, through which fuel remaining in the engine 20 is returned to the fuel tank 12, are connected to the fuel tank 12.

A level sensor 26 that detects the amount of fuel in the fuel tank 12 is disposed on an upper portion of the fuel tank 12. The level sensor 26 includes a float 28 and an arm 30. Arm 30 pivotally supports the float 28 which rises and falls in accordance with an increase and a decrease in the amount of fuel in the fuel tank 12.

A filler pipe 32 is disposed on one side of the fuel tank 12. The filler pipe 32 is connected to the fuel tank 12 and fuel is supplied to the fuel tank 12 through the filler pipe 32. Although not illustrated, an oil fill port may be formed in an upper end portion of the filler pipe 32. For example, the oil fill port may be positioned above the upper surface of the fuel tank 12. In the illustrated embodiment, a lower end portion of the filler pipe 32 is connected to the fuel tank 12 via a communication port 34. In the illustrated embodiment, a portion of the filler pipe 32 that is connected to the fuel tank 12 from outside the fuel tank 12 extends substantially horizontally. However, the filler pipe 32 may be disposed so as to be inclined downward to the left and/or in any other configuration that allows fuel supply system 10 to function as described herein.

Fuel supply system 10 includes a holding portion into which fuel additive 14 is injected. For example, in the exemplary embodiment, an extended portion 36 is joined to a fuel-tank-side end portion 33 of the filler pipe 32. The extended portion 36 is substantially horizontally extended by a predetermined length toward the inside of the fuel tank 12 from the communication port 34. Since the extended portion 36 is disposed inside the fuel tank 12 and in a portion into which fuel directly flows when the fuel is supplied to the fuel tank 12, the extended portion 36 functions as the holding portion into which fuel additive 14 is injected. As referred to herein, injecting fuel additive 14 into the holding portion includes providing the fuel additive to an interior of fuel tank 12 in such a manner that the fuel additive 14 flows through the fuel in the fuel tank 12 and accumulates in the holding portion due to the fuel additive 14 having a higher specific gravity than the fuel. The position of the extended portion 36 in the vertical direction with respect to a bottom of the fuel tank 12 is set at a level that is lower than a level of the fuel surface in the fuel tank 12 when a fuel-level gauge of an indicator (not shown in FIG. 1) indicates the fuel tank 12 is empty (“E”).

The extended portion 36 includes a top wall 38, a bottom wall 40, an inclined wall 42, and side walls (not shown in FIG. 1). The top wall 38 is continuous with the filler pipe 32 and protrudes from the communication port 34 toward the interior of the fuel tank 12. The bottom wall 40 is continuous with the filler pipe 32 and protrudes toward the interior of the fuel tank 12 to a larger extent than the top wall 38 does. The inclined wall 42 is inclined upward and toward a center of the interior of the fuel tank 12 from an end of the bottom wall 40. The side walls are continuous with the bottom wall 40. An opening 37 is defined at least partially by the inclined wall 42 and the top wall 38. The opening 37 guides the fuel additive 14 injected by an injector 44, which will be described below, to the bottom wall 40. The extended portion 36 and the filler pipe 32 may be formed as a continuous integrated unit or may be formed as separate units and then connected to each other at the end portion 33 of the filler pipe 32. In the same manner as the filler pipe 32, the extended portion 36 may have a substantially annular cross section when taken in a direction perpendicular to the axis direction of part of the filler pipe 32 near the end portion 33. Alternatively, unlike the filler pipe 32, the extended portion 36 may have, for example, a rectangular cross section. In the case where the filler pipe 32 and the extended portion 36 are formed as an integrated unit, the opening 37 may be formed by cutting off an end portion of the pipe-shaped unit.

In the illustrated embodiment, injector 44, which may also be referred to as an inlet, is positioned on a top surface of the fuel tank 12 above the extended portion 36 in the vertical direction. The injector 44 injects the fuel additive 14 into the fuel tank 12. The injector 44 may be equipped with a check valve 46 that prevents backflow of the fuel additive 14 injected into the fuel tank 12.

The storage tank 16 is equipped with a pump 48, which supplies the fuel additive 14 to the fuel tank 12 via the additive inlet pipe 18, and a controller 50. Controller 50 is communicatively coupled to the pump 48 to control the amount of the fuel additive 14 supplied to the fuel tank 12.

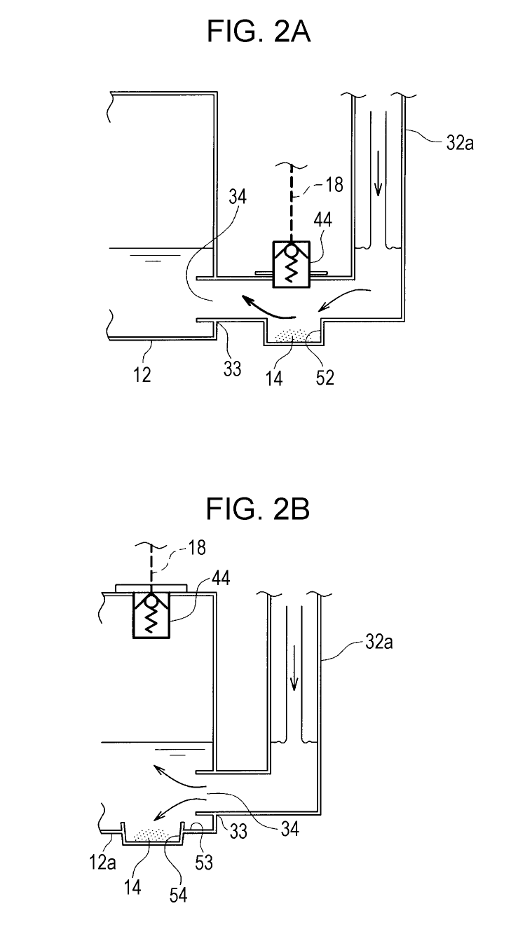

FIGS. 2A and 2B each illustrate an alternative embodiment of a holding portion that may be included in the fuel supply system 10 (shown in FIG. 1). Components that are the same as those illustrated in FIG. 1 are denoted by the same reference numerals and the detailed description thereof is omitted.

In the first alternative embodiment (shown in FIG. 2A), a filler pipe 32a includes a recessed portion 52, into which the fuel additive 14 is injected, at a position in front of the communication port 34 at which the filler pipe 32a is connected to the fuel tank 12. For example, the injector 44, which injects the fuel additive 14, may be disposed on a portion of the filler pipe 32a above the recessed portion 52 in the vertical direction. Since the recessed portion 52 is formed inside the filler pipe 32a and in a portion in which fuel directly flows when the fuel is supplied to the fuel tank 12, the recessed portion 52 functions as a holding portion into which a fuel additive 14 is injected.

The first alternative embodiment of the holding portion allows a fuel supply system to operate as described herein in vehicles where it is difficult to position injector 44 on the upper surface (e.g., top panel) of the fuel tank 12 due to factors such as the shape of the fuel tank 12 or the position of the vehicle to which the fuel tank 12 is attached. In the first alternative embodiment, the injector 44 and the recessed portion 52 (i.e., holding portion) are not positioned inside the fuel tank 12, but rather, are positioned inside the filler pipe 32a.

In the second alternative embodiment (shown in FIG. 2B) of the holding portion, a fuel tank 12A includes a recessed portion 54 into which the fuel additive 14 is injected by the injector 44. For example, recessed portion 54 may be formed in a lower end portion 53 of the fuel tank 12a near the communication port 34 facing the interior of fuel tank 12a. Since the recessed portion 54 is formed inside the fuel tank 12a and at a position where fuel directly flows when the fuel is supplied to the fuel tank 12a, the recessed portion 54 functions as a holding portion into which the fuel additive 14 is injected. According to the second alternative embodiment, the fuel tank 12a may be made, for example, by integral molding so as to include the recessed portion 54 by using a resin material, thereby reducing the manufacturing cost.

In the exemplary embodiment, fuel supply system 10 (shown in FIG. 1) may include extended portion 36 (shown in FIG. 1), recessed portion 52 (shown in FIG. 2A), recessed portion 54 (shown in FIG. 2B), and/or any other configuration of a holding portion that allows fuel supply system 10 to function as described herein.

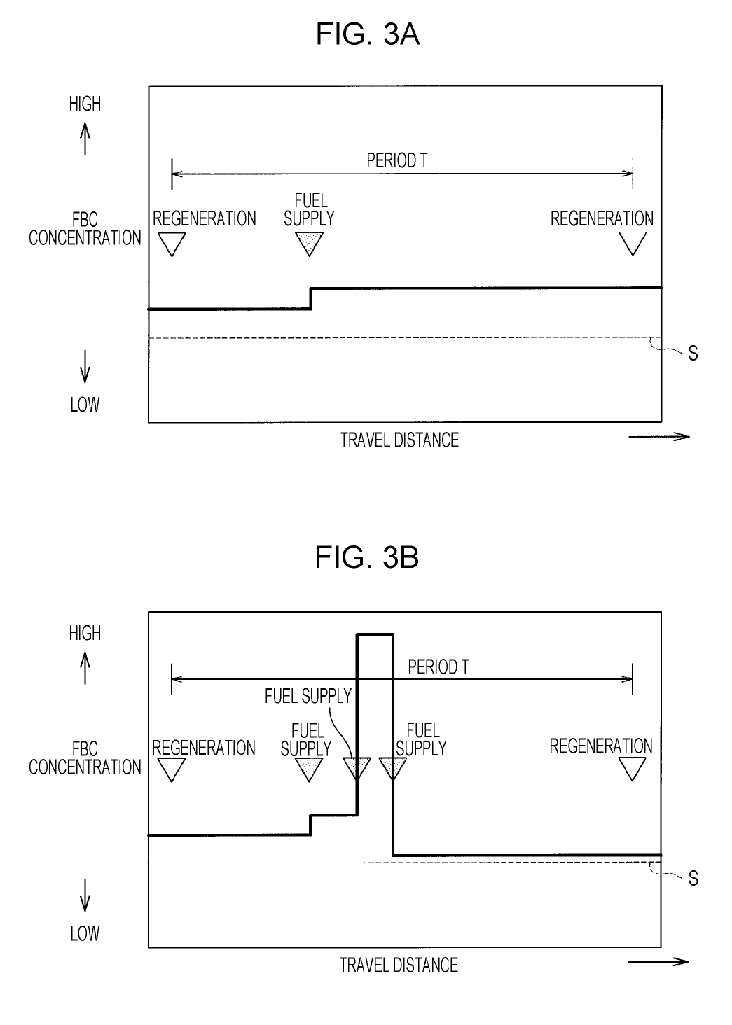

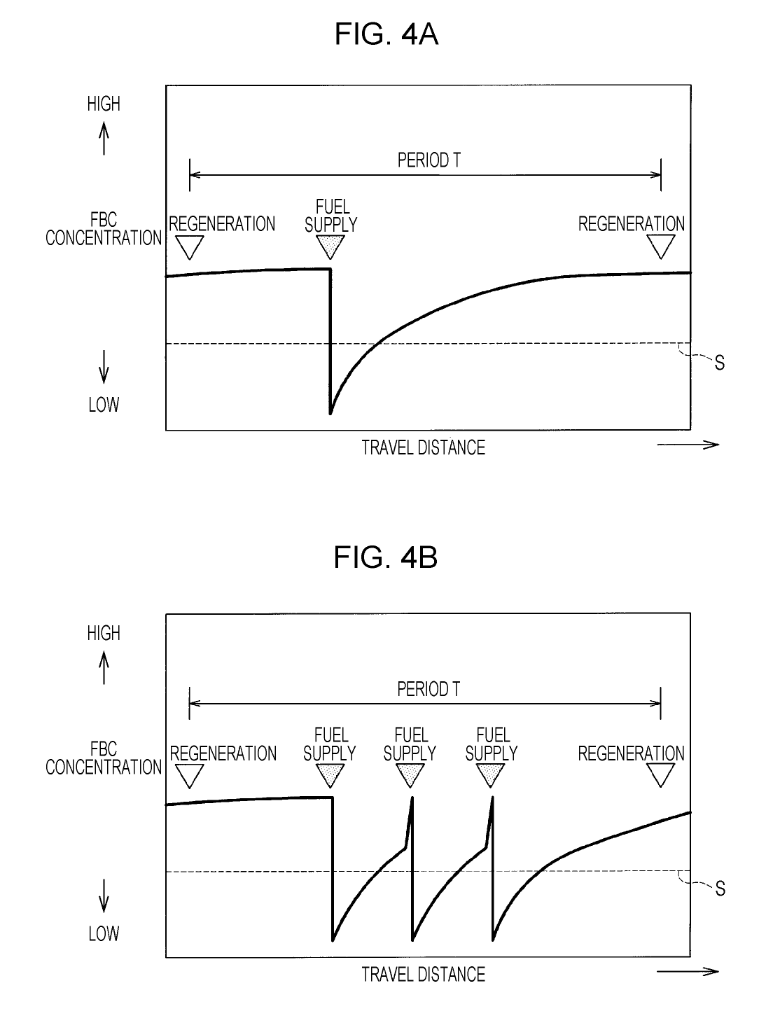

FIGS. 3A and 3B illustrate to what extent the fuel additive 14 is mixed in fuel during operation of a vehicle that includes fuel supply system 10. FIGS. 4A and 4B illustrate to what extent a fuel additive is mixed in fuel according to a comparative example. In contrast to the fuel supply system 10 described herein, the fuel supply system of the comparative example does not include the extended portion 36 (shown in FIG. 1), the recessed portion 52 (shown in FIG. 2A), or the recessed portion 54 (shown in FIG. 2B) that function as a holding portion.

In FIGS. 3A, 3B, 4A, and 4B, the horizontal axis indicates the travel distance of the vehicle and the vertical axis indicates the FBC concentration in fuel. In FIGS. 3A, 3B, 4A, and 4B, “regeneration” above a hollow triangle denotes “regeneration of diesel particulate filter (DPF)”, specifically, to burn off particulate matter (PM) captured by the DPF so that the DPF can capture PM again. The period T from “regeneration” to subsequent “regeneration” denotes a period during which PM accumulates in the DPF. In addition, “fuel supply” above a dotted triangle denotes a fuel supply operation in which a predetermined amount of fuel is supplied from the oil fill port of the filler pipe 32 via a nozzle. Furthermore, the broken line S indicates a minimum required level or a threshold above which the DPF regeneration efficiency is maintained.

In the fuel supply system 10, the fuel additive 14 that has been previously injected into the extended portion 36 by the injector 44 before a fuel supply operation is performed remains in the extended portion 36 as it is and the fuel additive 14 remaining in the extended portion 36 is spread by the flow of fuel during a fuel supply operation, in which fuel is supplied through the filler pipe 32 into the fuel tank 12 (see FIG. 3A). Consequently, although the amount of fuel in the fuel tank 12 is increased compared to that before the fuel supply operation is performed, the FBC concentration can be kept at or higher than the minimum required level, thereby advantageously preventing the FBC concentration from falling below the minimum required level.

In contrast, in the fuel supply system of the comparative example that does not include the extended portion 36, a fuel additive that has been previously injected into a fuel tank before a fuel supply operation is performed is estimated to remain at a lower end portion of the fuel tank due to the relationship between the specific gravity of the fuel and the specific gravity of the fuel additive. Thus, when a predetermined amount of fuel is added during the fuel supply operation and the amount of fuel in the fuel tank is increased, the FBC concentration is reduced to a level below the minimum required level (see FIG. 4A). Consequently, according to the comparative example, the FBC concentration falls below the minimum required level, and thus the DPF regeneration efficiency may be reduced.

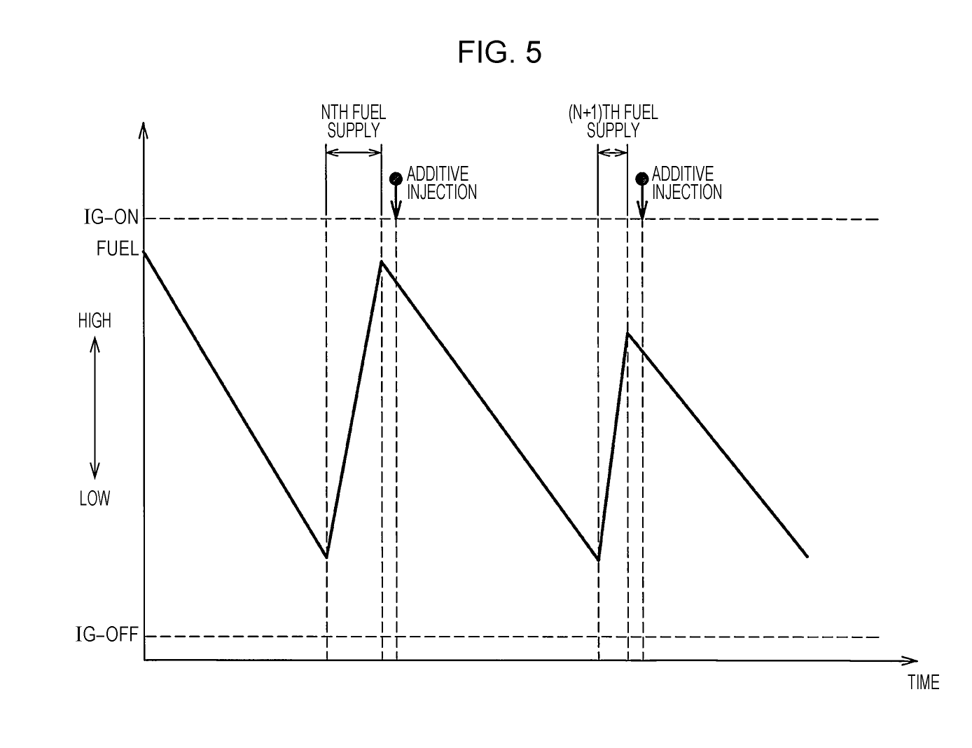

FIG. 3B illustrates how the FBC concentration changes within fuel supply system 10 when multiple fuel supply operations are performed during the period T. FIG. 5 illustrates the relationship between multiple fuel supply operations, the injection timing of the fuel additive, and the ignition state (IG-ON or IG-OFF) of a vehicle that includes fuel supply system 10. FIG. 4B illustrates how the FBC concentration changes when multiple fuel supply operations are performed during the period T according to the comparative example.

When multiple fuel supply operations are performed during the period T in the fuel supply system 10, the fuel additive 14 that has been previously injected into the extended portion 36 by the injector 44 before, for example, an (N+1)th fuel supply operation is performed remains in the extended portion 36 as it is. The fuel additive 14 remaining in the extended portion 36 is spread by the flow of fuel during the (N+1)th fuel supply operation, during which fuel is supplied through the filler pipe 32 to the fuel tank 12 (see FIGS. 3B and 5). Consequently, fuel supply system 10 facilitates maintaining the FBC concentration at or above the minimum required level (see FIG. 3B).

The fuel additive 14 is injected from the injector 44 after each fuel supply operation is performed and while the ignition switch is on (IG-ON). The first injection of the fuel additive 14 may be made at the factory before shipment of the vehicle. The injection of the fuel additive 14 may be performed while, for example, the vehicle is travelling. The amount of fuel supplied to the fuel tank 12 during the period between when the ignition switch is turned off (IG-OFF) and when the ignition switch is turned on (IG-ON) is detected by the level sensor 26 and the amount of the fuel additive 14 that is to be injected is calculated on the basis of the amount of fuel that has been supplied immediately before the injection and detected by the level sensor 26. For example, when an Nth fuel supply operation is performed, the amount of the fuel additive 14 to be injected after the ignition switch is turned on (IG-ON) is calculated on the basis of the amount of fuel supplied during the Nth fuel supply operation. When the (N+1)th fuel supply operation is performed, the amount of the fuel additive 14 to be injected after the ignition switch is turned on (IG-ON) is calculated on the basis of the amount of fuel supplied during the (N+1)th fuel supply operation.

In other words, the fuel additive 14 in the fuel supply system 10 that has been previously injected before each fuel supply operation is kept in the extended portion 36 in advance, and thus the fuel additive 14 kept in the extended portion 36 can be smoothly spread by the flow of fuel flowing through the filler pipe 32 during a fuel supply operation. Although the ignition switch is turned off (IG-OFF) during a fuel supply operation, the ignition switch is turned on (IG-ON) after the fuel supply operation is performed and thus the fuel pump, not illustrated, is driven. Consequently, the fuel additive 14 that has been spread by the flow of fuel can be further spread due to a suction effect of the fuel pump. Although the suction effect is exerted by the fuel pump disposed on the engine 20 side, driving of the fuel pump or sucking of the fuel additive 14 causes no problem.

Although the FBC concentration of fuel in fuel tank 12 becomes higher in some cases between fuel supply operations, as illustrated in FIG. 3B, such rise in the FBC concentration does not reduce the DPF regeneration efficiency. Moreover, the FBC concentration in fuel does not have to be uniform or substantially uniform after the fuel additive 14 is spread by the flow of fuel. A high FBC concentration area and a low FBC concentration area may coexist in the fuel tank 12.

On the other hand, in the comparative example as illustrated in FIG. 4B, the fuel additive that has been previously injected in the fuel tank before a fuel supply operation is performed is estimated to remain at a lower end portion of the fuel tank due to the relationship between the specific gravity of the fuel and the specific gravity of the fuel additive. The amount of fuel in the fuel tank is increased after each fuel supply operation is performed, and thus the FBC concentration is reduced to a level below the minimum required level. Consequently, in the comparative example, the FBC concentration falls below the minimum required level, and thus the DPF regeneration efficiency may be reduced.

As described herein, in the exemplary embodiment of the fuel supply system 10, the fuel additive 14 injected into the extended portion 36 (holding portion) is spread by the flow of fuel introduced into the fuel tank 12 during a fuel supply operation, and thus the concentration of the fuel additive 14 in the fuel can be kept at or higher than the minimum required level due to the dispersing effect of the flow of fuel. Furthermore, combustion of PM during DPF regeneration can be facilitated and an excessive amount of PM can be prevented from accumulating in the DPF. Consequently, the concentration of the fuel additive in the fuel can be kept at or higher than a predetermined value and the DPF regeneration efficiency can be advantageously prevented from decreasing. In addition, reduction of PM can lead to an improvement in fuel efficiency.

As described above, in the exemplary embodiment of the fuel supply system 10, the fuel additive 14 is injected in advance while the engine 20 is driving, and the injected fuel additive 14 is maintained in the extended portion 36, which extends toward a center of the fuel tank 12, until a subsequent fuel supply operation is performed.

Furthermore, the amount of the fuel additive 14 to be injected is determined in accordance with the amount of fuel supplied immediately before the injection. Thus, the fuel additive 14 can be kept in the extended portion 36 in accordance with the amount of fuel supply. In this case, the amount of fuel supplied to the fuel tank 12 between when the ignition switch is turned off (IG-OFF) and when the ignition switch is turned on (IG-ON) is detected by the level sensor 26 and the amount of the fuel additive 14 to be injected is calculated on the basis of the amount of fuel supplied immediately before the injection, the amount being detected by the level sensor 26.

Alternatively, the amount of the fuel additive 14 to be injected may be calculated without using the amount of fuel detected by the level sensor 26. Instead, the amount of the fuel additive 14 may be calculated on the basis of the sum total of the amount of fuel injected by a fuel injecting device of the engine 20 and computed by a controller. The fuel injecting device and the controller are not illustrated. Moreover, the arithmetic mean of the amounts of fuel supplied in multiple fuel supply operations may be calculated and the amount of the fuel additive 14 to be injected may be corrected in accordance with the deviation of the actual amount of fuel supplied from the arithmetic mean of the amount of fuel supplied.

In the exemplary embodiment, the fuel supply system 10 is associated with a diesel engine 20, however, the present disclosure is not limited to this application. As a non-limiting example, the fuel supply system 10 may also be associated with a gasoline engine wherein a fuel additive having a specific gravity larger than that of gasoline is injected into the gasoline engine.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fuel supply system comprising:
a fuel tank;
a filler pipe connected to the fuel tank and through which fuel is supplied to the fuel tank; and
a storage unit in which a fuel additive that is to be supplied to the fuel tank is stored,
wherein a holding portion is formed in a portion of an interior of at least one of the filler pipe and the fuel tank to which the fuel directly flows when the fuel tank is supplied with the fuel,
wherein the fuel tank has an inlet through which the fuel additive is injected from the storage unit into the fuel tank, and
wherein the fuel additive is injected into the holding portion.

2. The fuel supply system according to claim 1, wherein the holding portion is an extended portion formed such that a fuel-tank-side end portion of the filler pipe extends into the fuel tank.

3. The fuel supply system according to claim 1, wherein the holding portion is a recessed portion defined within at least one of the fuel tank and the filler pipe.

4. The fuel supply system according to claim 1, wherein a position of the holding portion in a vertical direction with respect to a bottom of the fuel tank is at a level that is lower than a level of the fuel surface in the fuel tank when a fuel-level gauge indicates the fuel tank is empty (“E”).

5. The fuel supply system according to claim 1, wherein an amount of the fuel additive to be injected is calculated based at least partially on the amount of fuel supplied immediately before the injection of the fuel additive.

6. The fuel supply system according to claim 1, the fuel supply system configured to supply fuel to an engine, wherein an amount of the fuel additive to be injected is calculated based at least partially on an amount of fuel injected by a fuel injecting device of the engine.

7. The fuel supply system according to claim 1, further comprising at least one diesel particulate filter, and wherein the holding portion is configured to facilitate maintaining the concentration of the fuel additive in the fuel at or above a predetermined value, wherein the predetermined value is associated with a concentration of the fuel additive that maintains a regeneration efficiency of the diesel particulate filter.

8. A method for supplying a fuel additive to fuel in a fuel tank, the fuel tank included within a fuel supply system that further includes a fuel additive injector, a filler pipe coupled to the fuel tank and configured to receive fuel, and a holding portion included within at least one of the fuel tank and the filler pipe and configured to store the fuel additive; said method comprising:
positioning the fuel additive injector substantially above the holding portion of the fuel supply system; and
positioning the holding portion of the fuel supply system in a path of a flow of fuel introduced into the fuel tank from the filler pipe.

9. The method in accordance with claim 8, further comprising configuring the holding portion to hold the fuel additive from the fuel additive injector that has traveled to the holding portion through the fuel due to the fuel additive having a specific gravity that is higher than the specific gravity of the fuel.

10. The method in accordance with claim 8, wherein positioning the holding portion in a path of a flow of fuel comprises defining a recessed portion within at least one of the filler pipe and the fuel tank.

11. The method in accordance with claim 8, wherein positioning the holding portion in a path of a flow of fuel comprises positioning an extended portion at an end portion of the filler pipe and configuring the extended portion to incline upward toward a center of the fuel tank.

12. The method in accordance with claim 8, further comprising configuring a controller to determine an amount of the fuel additive to be injected based at least partially on an amount of fuel supplied to the fuel tank prior to the fuel additive injection.

13. The method in accordance with claim 12, further comprising configuring the controller to determine the amount of the fuel additive to be injected based at least partially on an amount of fuel removed from the fuel tank by a fuel injecting device.

14. A fuel additive supply system associated with a fuel tank, said supply system comprising:
a holding portion defined at least partially within at least one of the fuel tank and a filler pipe associated with the fuel tank;
a fuel additive storage unit configured to store a fuel additive; and
a fuel additive injector coupled to at least one of the fuel tank and the filler pipe in a position above said holding portion and configured to provide the fuel additive to the holding portion.

15. The fuel additive supply system according to claim 14, wherein the holding portion comprises an extended portion formed such that a fuel-tank-side end portion of the filler pipe extends into the fuel tank.

16. The fuel additive supply system according to claim 14, wherein the holding portion is a recessed portion defined within at least one of the fuel tank and the filler pipe.

17. The fuel additive supply system according to claim 14, wherein a position of the holding portion in a vertical direction with respect to a bottom of the fuel tank is at a level that is lower than a level of the fuel surface in the fuel tank when a fuel-level gauge indicates the fuel tank is empty (“E”).

18. The fuel additive supply system according to claim 14, wherein an amount of the fuel additive to be injected is calculated based at least partially on the amount of fuel supplied immediately before the injection of the fuel additive.

19. The fuel additive supply system according to claim 14, the fuel supply system configured to supply fuel to an engine, wherein an amount of the fuel additive to be injected is calculated based at least partially on an amount of fuel injected by a fuel injecting device of the engine.

20. The fuel additive supply system according to claim 14, wherein the holding portion is configured to facilitate maintaining the concentration of the fuel additive in the fuel at or above a predetermined value, wherein the predetermined value is associated with a concentration of the fuel additive that maintains a regeneration efficiency of an associated diesel particulate filter.
